(19) United States
(12) Patent Application Publication
(10) Pub. No.: US 2018/0374177 A1
(43) Pub. Date: Dec. 27, 2018

(54) ELECTRONIC JUSTICE CITATION MOBILE USER INTERFACE METHOD, SYSTEM AND APPARATUS

(71) Applicant: Conduent Business Services, LLC, Dallas, TX (US)

(72) Inventor: Evangeline Dejoras, Cerritos, CA (US)

(73) Assignee: Conduent Business Services, LLC

(21) Appl. No.: 15/634,553

(22) Filed: Jun. 27, 2017

(51) Int. Cl. G06Q 50/26; G06F 3/0488; G06K 7/10

(52) U.S. Cl. CPC G06Q 50/265; G06F 3/0482; G06K 7/10554; G06F 3/04883

(57) ABSTRACT

A user interface method, apparatus, and system facilitated by a client device. One or more screens of a user interface can be displayed through a client device. The user interface allows a law enforcement officer to quickly collect, manage, and issue a citation to a violator through said client device in a minimal time.

### TECHNICAL FIELD

Embodiments are generally related to data-processing systems. Embodiments also relate to the issuance of electronic citations to violators by law enforcement officers. Embodiments additionally relate to mobile devices for facilitating the issuance of citations.

### BACKGROUND

The issuing of misdemeanor citations has conventionally been carried out manually via written citations or electronically through the use of mobile enablement.

The use of manual citations requires a maintenance process whereby citation books are routinely switched between officers to equalize their consumption, reduce waste, and account for every citation number issued. Manual citations also require a manual key entry process at the end of the day to convert paper tickets into digital records. The manual citations are stored after entry into the database. Since there is lag between issuance and data entry, citation processing personnel must take additional steps to process settlement of fees or protests during the lag.

Some innovative police departments are moving away from such clunky manual systems. They are also digitizing many other functions. As an example, the LAPD (Los Angeles Police Department) plans to issue Android-based smartphones to their 7,000 officers and migrate as many digital functions as makes sense to these mobile devices. The citation process is one of them.

Manual citation creation is sometimes error prone and requires officers to remember violation codes. This manual approach also requires secondary systems to access key information necessary for the ticket and can be difficult to read. For electronic ticketing, most conventional systems still require many steps and most still require additional information to be gathered from other in-vehicle sources. Since police officers have target durations for administering citations, conventional manual and electronic system do not efficiently accelerate the citation process.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for methods and systems for enabling law enforcement officers to issue citations to violators using a client device.

It is another aspect of the disclosed embodiments to provide for a user interface for a mobile application that allows law enforcement officers to manage and, issue citations to citizens through a mobile device.

It is another aspect of the disclosed embodiments to provide for methods and systems that eliminate problems associated with paper ticket creation and conventional digital ticketing systems.

The aforementioned aspects and other objectives and advantages can now be achieved as described herein. User interface methods and systems facilitated by a client device are disclosed herein. One or more screens of a user interface can be displayed through a client device. The user interface allows a law enforcement officer to quickly collect, manage, and issue a citation to a violator through said client device in minimal time.

The disclosed user interface can be implemented with a mobile application, which enables law enforcement officers to issue citations to citizens using said client device (e.g., a mobile device such as a smartphone, table computing device, laptop computer, etc.). The user interface can be implemented in the contest of a gestural touch UI interaction model that allows officers to capture information three ways: 1) by touch entry/selection; 2) by connecting with in-vehicle databases to automatically ingest required citizen information; and 3) by ingesting information from optical/barcode scanners. The disclosed embodiments allow an officer to quickly and correctly complete a citation primarily during traffic stops where minimal roadside time is highly desired and required by most police departments.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a system that includes one or more networks that may connect servers and clients, in accordance with one or more example embodiments;

FIG. 2 illustrates a schematic diagram of a system that includes a server that may utilize and/or implement at least a portion of the techniques presented herein, in accordance with one or more example embodiments;

FIG. 3 is an illustration of a scenario involving an example configuration of a client that may utilize and/or implement at least a portion of the techniques presented herein, in accordance with one or more example embodiments;

FIG. 4 illustrates a smartphone and a display screen of a touch screen user interface, in accordance with an example embodiment;

FIG. 5 illustrates a smartphone and another display screen of a touch screen user interface, in accordance with an example embodiment;

FIG. 6 illustrates a smartphone and yet another display screen of a touch screen user interface, in accordance with an example embodiment;

FIG. 7 illustrates a smartphone and another display screen of a touch screen user interface, in accordance with an example embodiment;

FIG. 8 illustrates a smartphone and another display screen of a touch screen user interface, in accordance with an example embodiment;

FIG. 9 illustrates a smartphone and another display screen of a touch screen user interface, in accordance with an example embodiment;

FIG. 10 illustrates a flow chart of operations depicting logical operational steps of a method for implementing a justice citation mobile user interface or “eCitation” application, in accordance with an example embodiment;

FIG. 11 illustrates screen shots of screens associated with a driver tab, in accordance with an example embodiment;

FIG. 12 illustrates a screen shot of screens for obtaining a driver signature and thumbprint, in accordance with an example embodiment;

FIG. 13 illustrates screen shots of screens for obtaining a driver signature, in accordance with an example embodiment;

FIG. 14 illustrates screen shots of screens for obtaining a driver fingerprint, in accordance with an example embodiment;

FIG. 15 illustrates screen shots of screens for obtaining a driver thumbprint, in accordance with an example embodiment;

FIGS. 16-17 illustrate screen shots of screens associated with a vehicle tab, in accordance with an example embodiment; and

FIGS. 18-21 illustrate screen shots of screens associated with a violations tab, in accordance with an example embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems/devices. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,”“or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Additionally, the term “step” can be utilized interchangeably with “instruction” or “operation.”

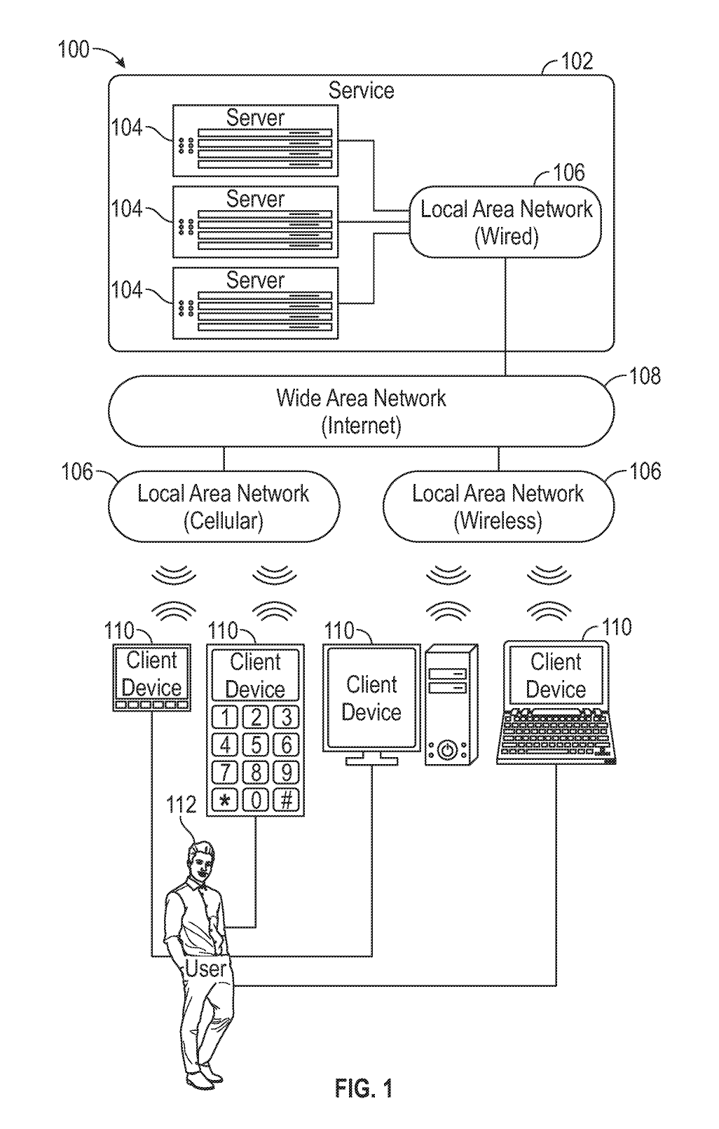

FIG. 1 illustrates a block diagram of a system 100 that includes a service 102 provided by a set of servers 104 to a set of client devices 110 via various types of networks. The servers 104 and/or client device(s) 110 may be capable of transmitting, receiving, processing, and/or storing many types of signals, such as in memory as physical memory states. Examples of client device(s) 110 include mobile devices such as a smartphone, tablet computing device, wearable computing devices, and so on. Other examples of client device(s) include a desktop computer, a laptop computer, and so on.

The server(s) 104 of the service 102 may be internally connected via a local area network 106 (LAN), such as a wired network where network adapters on the respective servers 104 are interconnected via cables (e.g., coaxial and/or fiber optic cabling), and may be connected in various topologies (e.g., buses, token rings, meshes, and/or trees). The servers 104 may be interconnected directly or through one or more other networking devices, such as routers, switches, and/or repeaters. The servers 104 may utilize a variety of physical networking protocols (e.g., Ethernet and/or Fibre Channel) and/or logical networking protocols (e.g., variants of an Internet Protocol (IP), a Transmission Control Protocol (TCP), and/or a User Datagram Protocol (UDP). The local area network 106 may include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 may be organized according to one or more network architectures, such as server/client, peer-to-peer, and/or mesh architectures, and/or a variety of roles, such as administrative servers, authentication servers, security monitor servers, data stores for objects such as files and databases, business logic servers, time synchronization servers, and/or front-end servers providing a user-facing interface for the service 102.

Likewise, the local area network 106 may comprise one or more sub-networks, such as may employ differing architectures, may be compliant or compatible with differing protocols and/or may interoperate within the local area network 106. Additionally, a variety of local area networks 106 may be interconnected, e.g., a router may provide a link between otherwise separate and independent local area networks 106.

In the system 100 of FIG. 1, the local area network 106 of the service 102 is connected to a wide area network 108 (WAN) that allows the service 102 to exchange data with other services 102 and/or client devices 110. The wide area network 108 may encompass various combinations of devices with varying levels of distribution and exposure, such as a public wide-area network (e.g., the Internet) and/or a private network (e.g., a virtual private network (VPN) of a distributed enterprise).

Additionally, in the scenario 100 of FIG. 1, the service 102 may be accessed via the wide area network 108 by a user 112 of one or more client devices 110, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 110 may communicate with the service 102 via various connections to the wide area network 108. As a first such example, one or more client devices 110 may comprise a cellular communicator and may communicate with the service 102 by connecting to the wide area network 108 via a wireless local area network 106 provided by a cellular provider. As a second such example, one or more client devices 110 may communicate with the service 102 by connecting to the wide area network 108 via a wireless local area network 106 provided by a location such as the users home or workplace (e.g., a WiFi network or a Bluetooth personal area network). In this manner, the servers 104 and the client devices 110 may communicate over various types of networks. Other types of networks that may be accessed by the servers 104 and/or client devices 110 include mass storage, such as network attached storage (NAS), a storage area network (SAN), or other forms of computer or machine readable media.

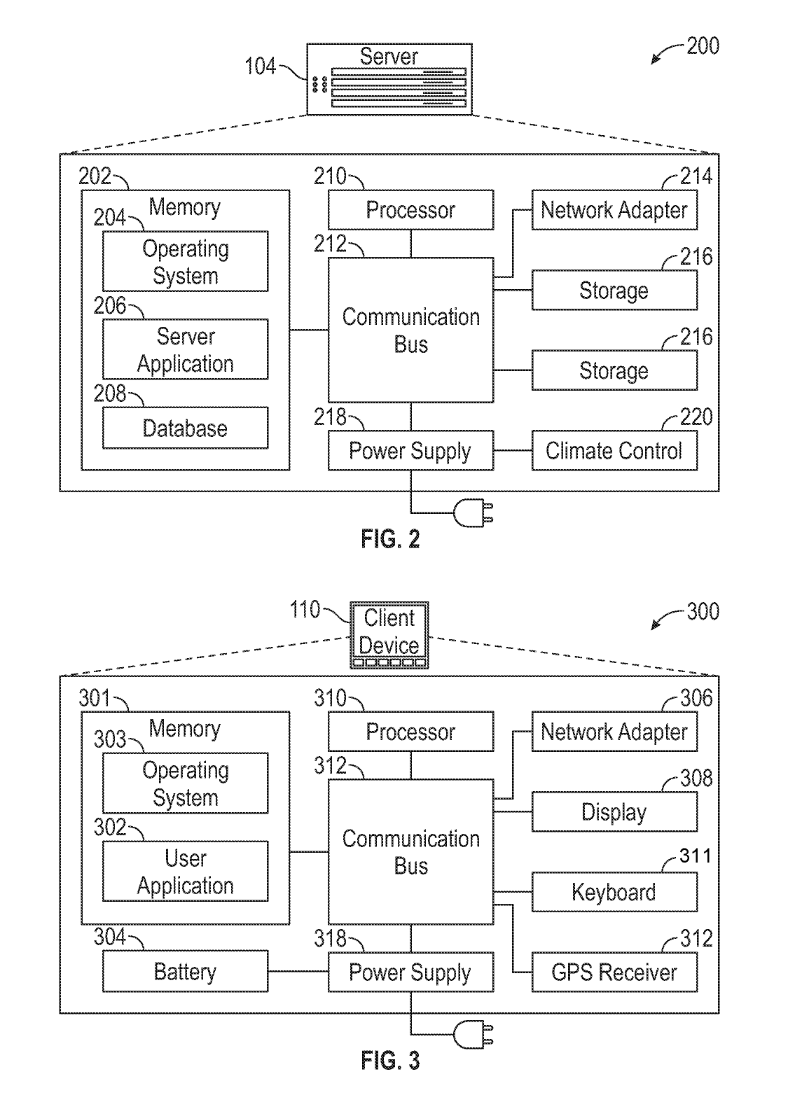

FIG. 2 illustrates a schematic diagram of a system 200 that includes a server 104 that may utilize at least a portion of the techniques provided herein, in accordance with one or more example embodiments. Such a server 104 may vary widely in configuration or capabilities, alone or in conjunction with other servers, in order to provide a service such as the service 102.

The server 104 may comprise one or more processors 210 that process instructions (e.g., such as the steps or operations described herein). The one or more processors 210 may optionally include a plurality of cores; one or more coprocessors, such as a mathematics coprocessor or an integrated graphical processing unit (GPU); and/or one or more layers of local cache memory. The server 104 may comprise memory 202 storing various forms of applications, such as an operating system 204; one or more server applications 206, such as a hypertext transport protocol (HTTP) server, a file transfer protocol (FTP) server, or a simple mail transport protocol (SMTP) server; and/or various forms of data, such as a database 208 or a file system. The server 104 may comprise a variety of peripheral components, such as a wired and/or wireless network adapter 214 connectible to a local area network and/or wide area network; one or more storage components 216, such as a hard disk drive, a solid-state storage device (SSD), a flash memory device, and/or a magnetic and/or optical disk reader.

The server 104 may comprise a main board featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 212 may interconnect the server 104 with at least one other server. Other components that may, optionally be included with the server 104 (though not shown in the schematic diagram 200 of FIG. 2) include a display; a display adapter, such as a graphical processing unit (GPU); input peripherals, such as a keyboard and/or mouse; and a flash memory device that may store a basic input/output system (BIOS) routine that facilitates booting the server 104 to a state of readiness.

The server 104 may operate in various physical enclosures, such as a desktop or tower, and/or may be integrated with a display as an “all-in-one” device. The server 104 may be mounted horizontally and/or in a cabinet or rack, and/or may simply comprise an interconnected set of components. The server 104 may comprise a dedicated and/or shared power supply 218 that supplies and/or regulates power for the other components. The server 104 may provide power to and/or receive power from another server and/or other devices. The server 104 may comprise a shared and/or dedicated climate control unit 220 that regulates climate properties, such as temperature, humidity, and/or airflow. Many such servers 104 may be configured and/or adapted to utilize at least a portion of the techniques presented herein.

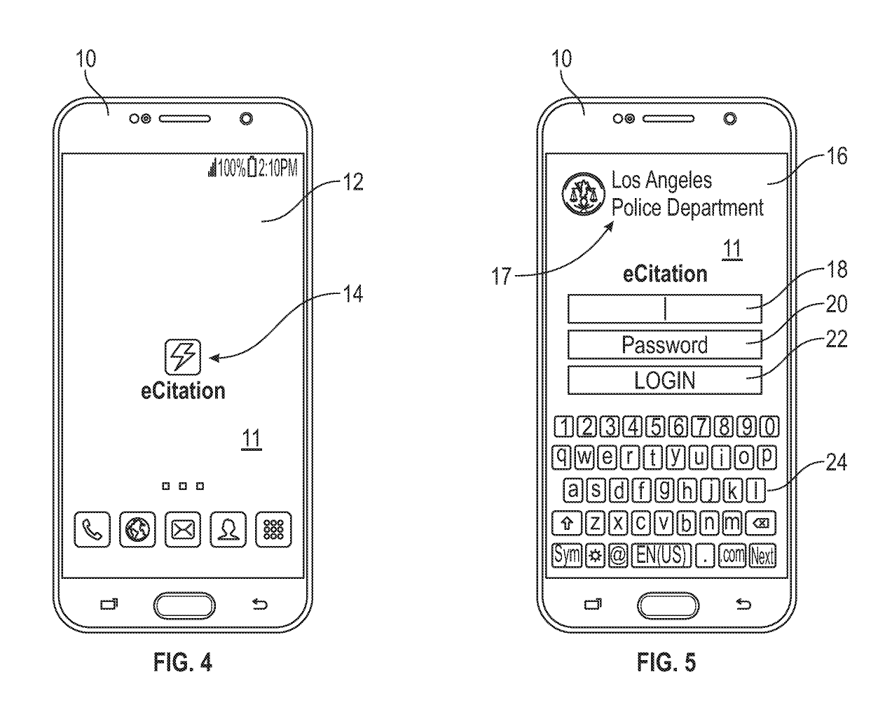

FIG. 3 illustrates a schematic diagram of a system 300 that includes a client device 110 whereupon at least a portion of the techniques presented herein may be implemented, in accordance with one or more example embodiments. Such a client device 110 may vary widely in configuration or capabilities. In order to provide a variety of functionality to a user such as the user 112. The client device 110 may be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 110 may serve the user in a variety of roles, such as a workstation, kiosk, media player, gaming device and/or appliance.

The client device 110 may comprise one or more processors 310 that process instructions. The one or more processors 310 may optionally include a plurality of cores; one or more coprocessors, such as a mathematics coprocessor or an integrated graphical processing unit (GPU); and/or one or more layers of local cache memory. The client device 110 may comprise memory 301 storing various forms of applications, such as an operating system 303; one or more user applications 302, such as document applications, media applications, file and/or data access applications, communication applications such as web browsers and/or email clients, utilities, and/or games; and/or drivers for various peripherals.

The client device 110 may comprise a variety of peripheral components, such as a wired and/or wireless network adapter 306 connectible to a local area network and/or wide area network; one or more output components, such as a display 308 coupled with a display adapter (optionally including a graphical processing unit (GPU)), a sound adapter coupled with a speaker, and/or a printer; input devices for receiving input from the user, such as a keyboard 311, a mouse, a microphone, a camera, and/or a touch-sensitive component of the display 308; and/or environmental sensors, such as a global positioning system (GPS) receiver 312 that detects the location, velocity, and/or acceleration of the client device 110, a compass, accelerometer, and/or gyroscope that detects a physical orientation of the client device 110.

Other components that may optionally be included with the client device 110 (though not shown in the schematic diagram 300 of FIG. 3) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 110 to a state of readiness; and a climate control unit that regulates climate properties, such as temperature, humidity, and airflow.

The client device 110 may comprise a main board featuring one or more communication buses 312 that interconnect the processor 310, the memory 301, and various peripherals, using a variety of bus technologies, such as a variant of a serial or, parallel AT Attachment (ATA) bus protocol; the Uniform Serial Bus (USB) protocol; and/or the Small Computer System Interface (SCI) bus protocol. The client device 110 may comprise a dedicated and/or shared power supply 318 that supplies and/or regulates power for other components, and/or a battery 304 that stores power for use while the client device 110 is not connected to a power source via the power supply 318. The client device 110 may provide power to and/or receive power from other client devices.

In some scenarios, as a user 112 interacts with a software application on a client device 110 (e.g., an instant messenger and/or electronic mail application), descriptive content in the form of signals or stored physical states within memory (e.g., an email address, instant messenger identifier, phone number, postal address, message content, date, and/or time) may be identified. Descriptive content may be stored, typically along with contextual content. For example, the source of a phone number (e.g., a communication received from another user via an instant messenger application) may be stored as contextual content associated with the phone number. Contextual content, therefore, may identify circumstances surrounding receipt of a phone number (e.g., the date or time that the phone number was received), and may be associated with descriptive content. Contextual content, may, for example, be used to subsequently search for associated descriptive content. For example, a search for phone numbers received from specific individuals, received via an instant messenger application or at a given date or time, may be initiated. The client device 110 may include one or more servers that may locally serve the client device 110 and/or other client devices of the user 112 and/or other individuals. For example, a locally installed web server may provide web content in response to locally submitted web requests. Many such client devices 110 may be configured and/or adapted to utilize at least a portion of the techniques presented herein.

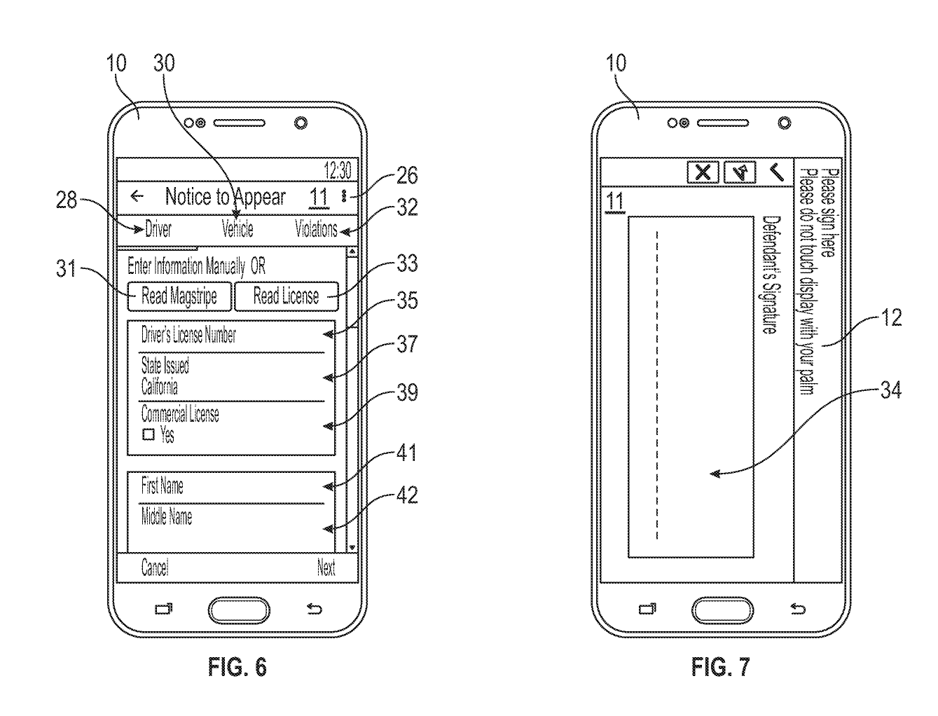

FIG. 4 illustrates a mobile device 10 (e.g., a smartphone, a tablet computing device, a wearable computing device, etc.) and, a display screen 12 of a touch screen User Interface (UI) 11, in accordance with an example embodiment. The smartphone shown in FIGS. 4-9 is an example of a client device, such as, for example, client device(s) 110 shown in FIGS. 1 and 3 herein. Note that in FIGS. 4-9, identical or similar parts are indicated by identical reference numerals. Thus, a mobile device 10 is depicted in FIGS. 4-9 with different screens of the user interface 11. Note that the term User Interface (UI) as utilized herein generally refers to everything designed into an information device with which a person may interact. This can include display screens, keyboards, a pointing device such as a mouse, and the appearance of a mobile device 10 (e.g., a smartphone, tablet computing device, wearable computing device, etc.). A UI is also the way through which a user can interact with an application (e.g., a mobile “app”) or a website. An example of a UI is a GUI (Graphical User Interface). A GUI is a particular type of UI that allows a user to interact with electronic through graphical icons and visual indicators such as secondary notation, instead of text-based user interfaces, typed command labels or text navigation. The actions in a GUI are usually performed through direct manipulation of the graphical elements.

Note that the various screens illustrated herein can be implemented in the context of a mobile device 10. Such a mobile device 10 may include a display, GUI logic, and mobile application logic. Such GUI logic may be implemented as a set of program instructions which, when executed by one or more processors of such a mobile device 10, are operable to receive user input and to display a graphical representation of one or more graphic constructs related to the mobile data analysis system approaches described herein. As an example, such a mobile device 10 may be a smartphone and such GUI logic may be operable to receive touch screen signals and other user input from, and display the graphics constructs to, a GUI that is provided on a mobile device 10's display. Touch screen signals may comprise selecting buttons, holding down buttons, selecting items displayed on the screen, dragging, or other gestures or selections. In general, such GUI logic can be configured to receive user input and determine what user requests or commands are represented by the user input.

In an example embodiment, such a mobile device 10 includes mobile application logic, which may comprise firmware, hardware, software, or a combination thereof in various embodiments that is configured to implement the functions of a mobile data analysis system on a mobile device 10 as described herein. In one example embodiment, such mobile application logic may be implemented as part of an application program configured to execute on the Android operating system. In other example embodiments, mobile application logic may be implemented as a combination of programming instructions written in any programming language (e.g., C++ or Java) and hardware components (e.g., memory, CPU time) that have been allocated for executing the program instructions on the mobile device 10.

In any event shown in FIG. 4, the mobile device (e.g., smartphone) 10 can include the display or display screen 12, which displays an “app” icon 14 that when selected by a user activates the display of other screens. The icon 14 is an example of an icon, which is a displayed graphical image that represents an application (“app”), a capability, or some other concept or specific entity with meaning for the user. An icon is usually selectable, but can also be a nonselectable image such as a company's logo. In the example shown in FIG. 4, the icon 14 when selected initiates loading and running of an “eCitation” application or “app.”

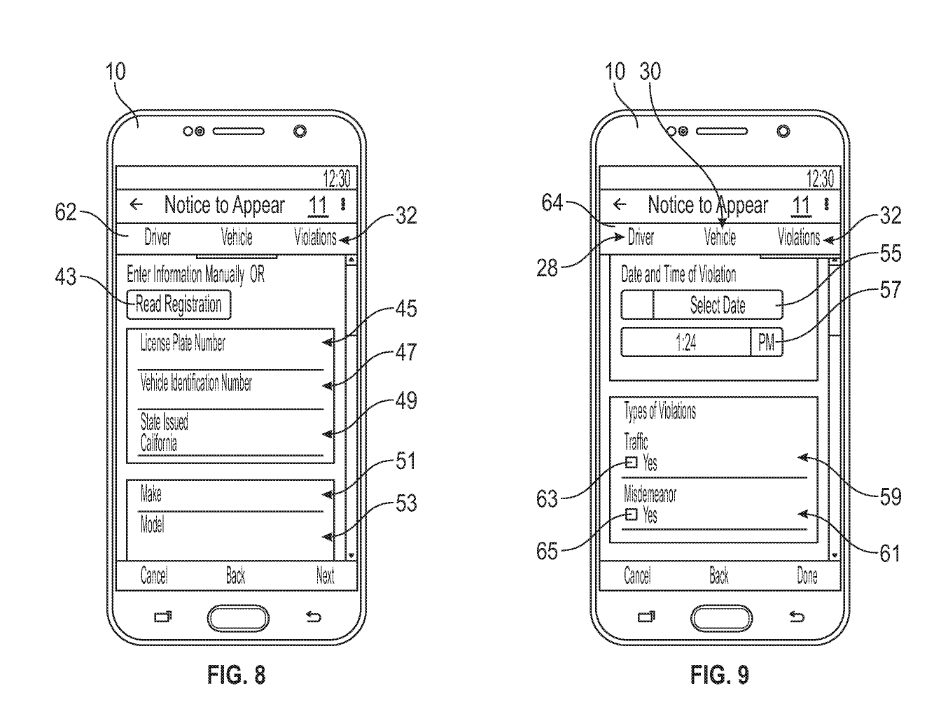

FIG. 5 illustrates the mobile device 10 and another display screen 16 of the touch screen user interface 11, in accordance with an example embodiment. The display screen 16 can be displayed in response to selection of the icon 14 shown in FIG. 4. The display screen 16 allows a user (e.g., a police officer) to enter the “eCitation” application or “app.” The screen 16 shown in FIG. 5 displays fields 18 and 20 for respectively entering a username and a password, which are used to validate or authenticate the user, thereby allowing the user further access to the “eCitation” app. A graphical button 22, when selected by a user, allows for submission of the username and password. A graphically displayed keyboard 24 is also displayed via screen 11, which allows a user to input data to the “app” and/or the mobile device 10.

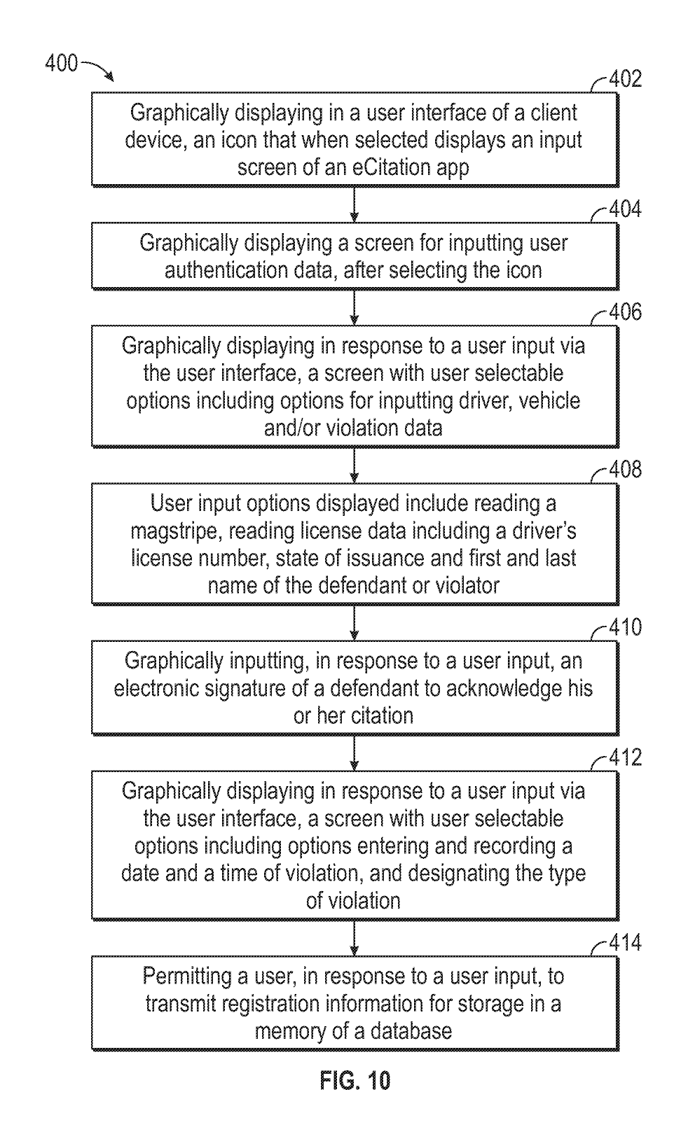

FIG. 6 illustrates the mobile device 10 and another display screen 26, which includes a driver tab 28, of the touch screen user interface 11, in accordance with an example embodiment. The eCitation app includes display screen 16, which displays a “Notice to Appear” screen with a heading titled “Notice to Appear” above tabs 28, 30, and 32, respectively labeled Driver, Vehicle, and Violations. The officer can move between these headers by clicking on the header name or the Cancel and Next buttons at the bottom of the screen.

In the driver tab 28 shown in FIG. 6, the display screen also can display graphically displayed buttons 31 and 33. The button 31, for example, when activated by a user initiates a “Read Magstripe” mode (e.g., reading of a driver's licenses magnetic strip). To enable this function, a magnetic strip reader is attached to the smartphone. The button 33 imitates a “Read License” mode. This button allows the officer to scan the barcode on the back of the driver's license using the smartphone's scanner. Fields 35 (“Driver's License Number”), 37 (“State Issued”), 39 (“Commercial License”), 41 (“First Name”), 42 (“Middle Name”), Last Name, Address, Birthdate, Age, Gender, Hair Color, Eye Color, Height and Weight are automatically populated with data. If these two methods fail, an officer can enter the information directly on the fields. Each field has an auto-suggest and auto-complete feature when entering information manually. If the officer has access to the Motor Vehicle Registry server in his current location, entering the driver's license number will auto-complete all the fields regarding the vehicle. The officer can manually enter Race if required by the police department and an additional description of significance to the incident.

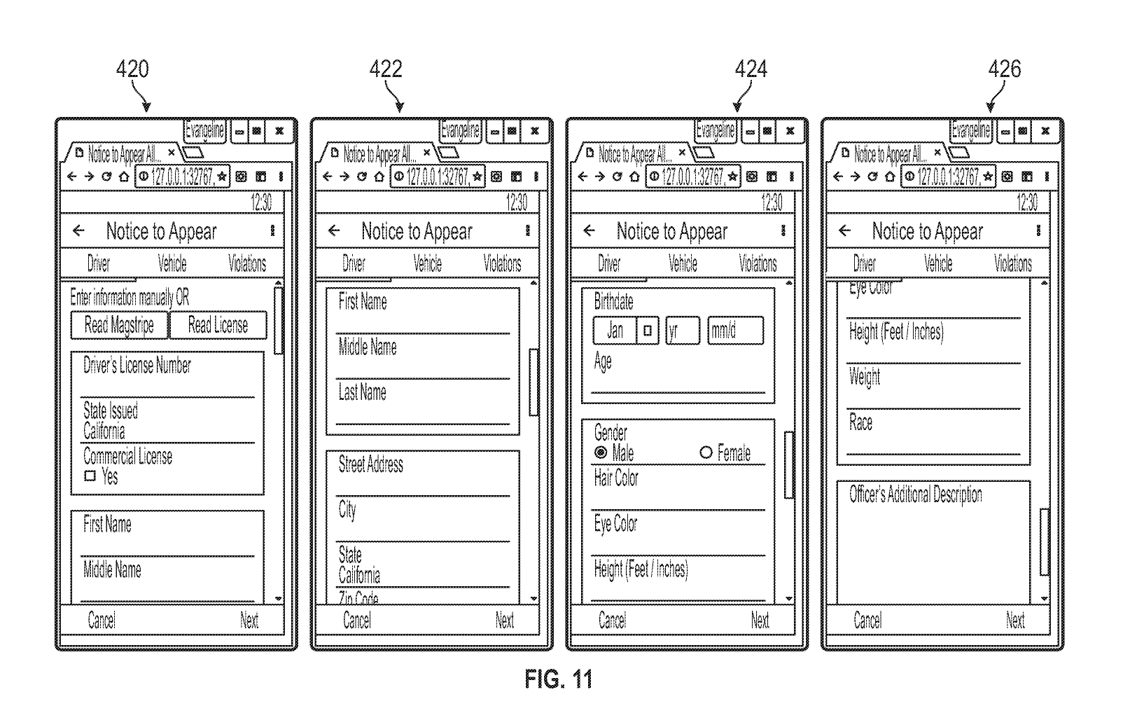

FIG. 7 illustrates the mobile device 10 and another display screen of the touch screen user interface 11, in accordance with an example embodiment. The display screen of the eCitation app allows for a user (e.g., a violator, defendant, etc.) to sign his or her name to acknowledge the citation issued through the eCitation app. The signature can be input via field 34. This step occurs after the Notice to Appear form is completed.

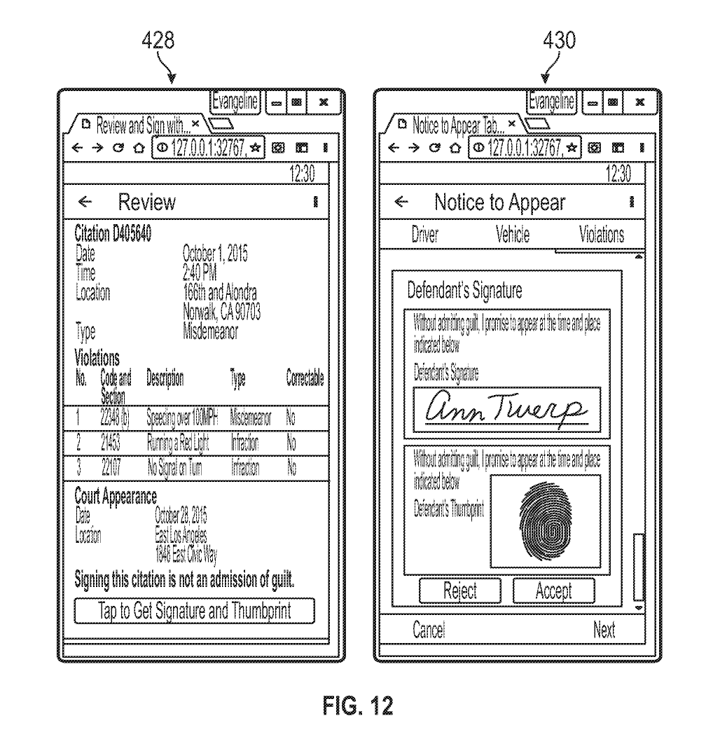

FIG. 8 illustrates the mobile device 10 and another display screen 62, The Vehicle Tab, of the touch screen user interface 11, in accordance with an example embodiment. The display screen 62 is a variation of the display screen 26 shown in FIG. 6. This display screen 62 includes a graphically displayed button 43 that when activated imitates reading of registration data. The officer would scan the barcode on the registration paper. Fields 45, 47, 49, 51, 53, Year, Body Style, Color and Commercial Vehicle, class, Name and Address of the Registered Owner are automatically populated with data. If the registration is not readable or not available, the officer can enter all the information manually. Each field can offer an auto-suggest and auto-complete feature when entering information manually. If the officer has access to the Motor Vehicle Registry server in his current location, entering the license plate number or the VIN will auto-complete all the fields stored in the server. Other fields can be completed by manual entry only such as Evidence of Financial Responsibility. This information is entered with respect to the “violations” header 32 displayed in screen 62.

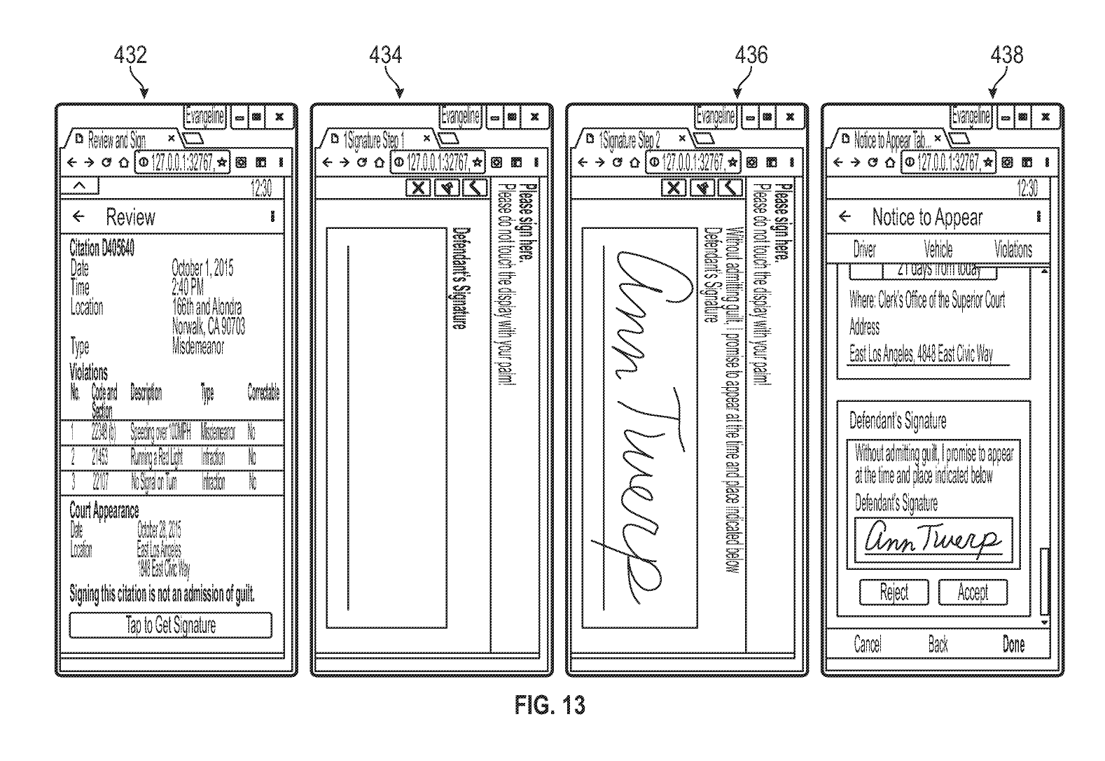

FIG. 9 illustrates the mobile device 10 and another display screen 64, which includes the violations tab 32 of the touch screen user interface 11, in accordance with an example embodiment. The display screen 64 includes a field 55 and a field 57 which are auto-populated. The officer can override 55 and 57 if the apprehension occurs minutes after the violation. Fields 59 and 61 allow a user to select the type of violation via selection buttons 63 and 65 (respectively, “Yes” selection buttons). An officer can perform a search for the Violation Code by clicking the search icon. For common violation codes, the officer can enter the code manually and the field will auto-complete with the vehicle code and section. S/he can enter additional violations. The user enters most information manually in this tab, but there are expediters and helpers, such as the Direction of Travel. The name of the Citing Officer is modifiable if the citing officer is not the officer assigned to the smartphone unit. To simplify the design, additional information can be hidden until required. An example of this is Arresting Officer Summoned and Court Appearance Required.

At the bottom of the Violations Tab, the officer has the option to Get a Signature, Get a Thumbprint, or Get a Signature and a Thumbprint. Upon clicking on, any of these buttons, the officer is asked to review the citation. From the Review page, the officer can click on a button to obtain a signature, or obtain a thumbprint, or obtain both. The officer can review the signature and the thumbprint and must accept or reject it. (Please note that the technology to obtain the signature and the thumbprint are not novel and therefore not part of this invention disclosure. However, it is the design flow for obtaining signatures and thumbprints that are part of the invention disclosure.)

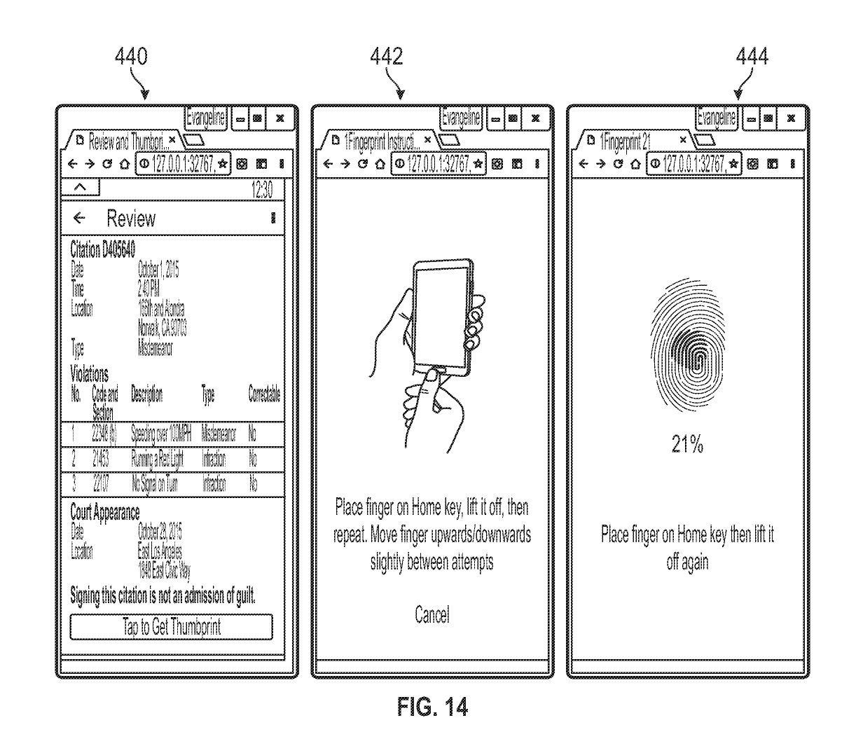

FIG. 10 illustrates a flow chart of operations depicting logical operational steps of a method 400 for implementing a justice citation mobile user interface or “eCitation” application, in accordance with an example embodiment. It should be appreciated that the ordering of the steps or operations depicted as shown in FIG. 10 may vary, depending on the particular embodiment implemented. That is, the steps shown in FIG. 10 may be sequential or may be arranged in a different order and thus the method 400 depicted in FIG. 10 is not limited to the particular sequence shown. Additionally, it can be appreciated that the method 400 may include fewer or more than the steps or operations depicted in FIG. 10.

Thus, as indicated at block 402, a step or operation can be implemented for graphically displaying in a user interface 11 of a client device such as the previously discussed mobile device 10, a graphical icon that when selected by a user displays an input screen or other screens of the disclosed “eCitation” application. Next, as depicted at block 404, a step or operation can be implemented for graphically displaying a screen for inputting user authentication data, after selecting the aforementioned icon. An example of such a screen is the screen 16 shown in FIG. 5, which graphically displays fields 18 and 20 and button 22 for logging into the eCitation application.

As shown next at block 406, a step or operation can be provided for graphically displaying, in response to a user input (and via the discussed user interface), a screen that graphically displays user selectable options including options for inputting driver, vehicle, and/or violation data. An example of such a screen is the screen 26 shown in FIG. 6. Thereafter, as depicted at block 408, a step or operation can be implemented in which the aforementioned screen (for inputting driver, vehicle, and/or violation data) displays options for reading license data from, for example, magstripe (i.e., the “magnetic strip” of a driver's license) and displaying and recording this information (e.g., driver's license number, state of issuance, first and last name of defendant or violator, and so on). Note that the operation shown in block 408 can also include providing options for the user (e.g., a law enforcement officer) to scan a barcode or a matrix barcode with the smartphone.

Thereafter, as depicted at block 410, a step or operation can be implemented for graphically inputting, in response to a user input, an electronic signature of a defendant to acknowledge his or her citation. An example of such a screen is the screen shown in FIG. 7. Next, as indicated at block 412, a step or operation can be provided for graphically displaying, in response to a user input through the user interface, a screen with user selectable options such as, for example, options that allow a user to enter and record the date and time of the violation, and designating the type of violation. An example of such a screen is the screen 64 shown in FIG. 9. Next, as indicated at block 414, a step or operation can be implemented for permitting a user, in response to a user input through the user interface, to transmit registration information for storage in a memory of a database. An example of a screen that facilitates this step or operation is the screen 62 shown in FIG. 8 (i.e., see the “Send Registration” button).

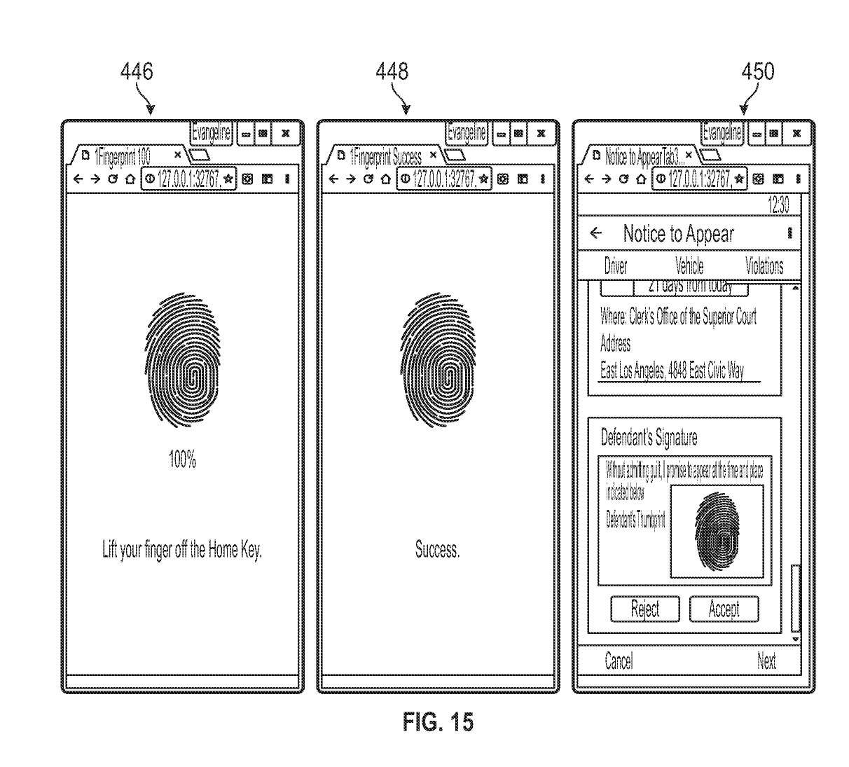

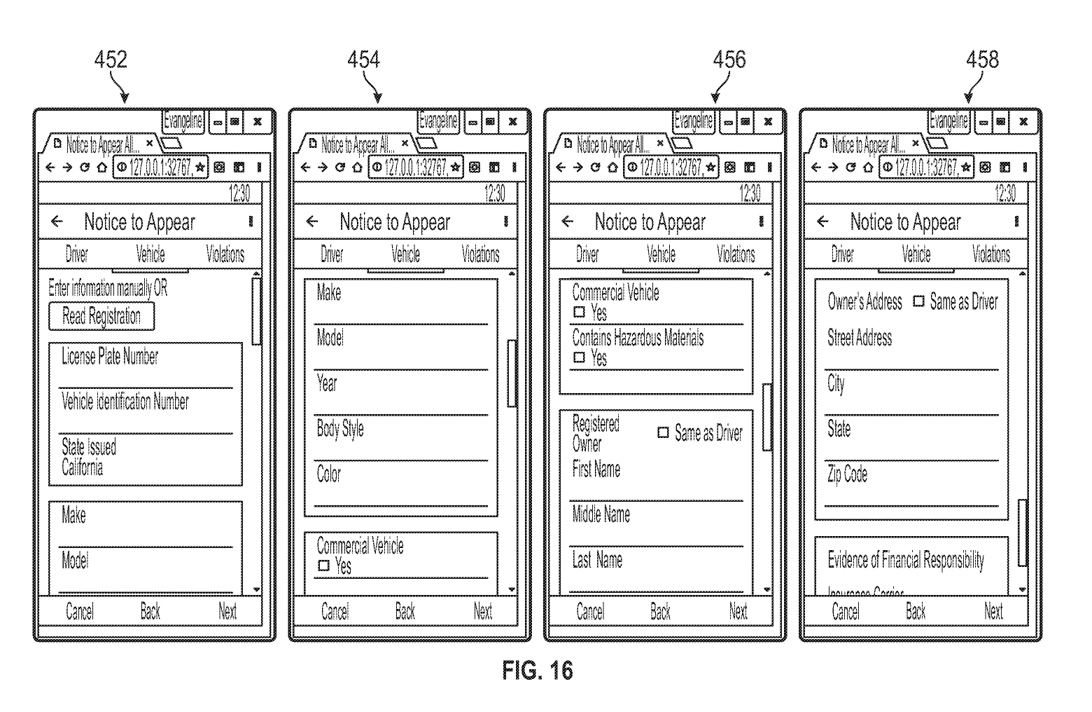

FIG. 11 illustrates screen shots of screens 420, 422, 424, and 426 associated with a driver tab, in accordance with an example embodiment. FIG. 12 illustrates screen shots of screens 428 and 430 for obtaining a driver signature and a thumbprint, in accordance with an example embodiment. In FIG. 12, the left hand screen 428 is shown as displaying citation, violation, and court appearance information for review. The right hand screen 430 displays a defendant's signature and an area for rejecting or accepting both the signature and a fingerprint rendering associated with the defendant.

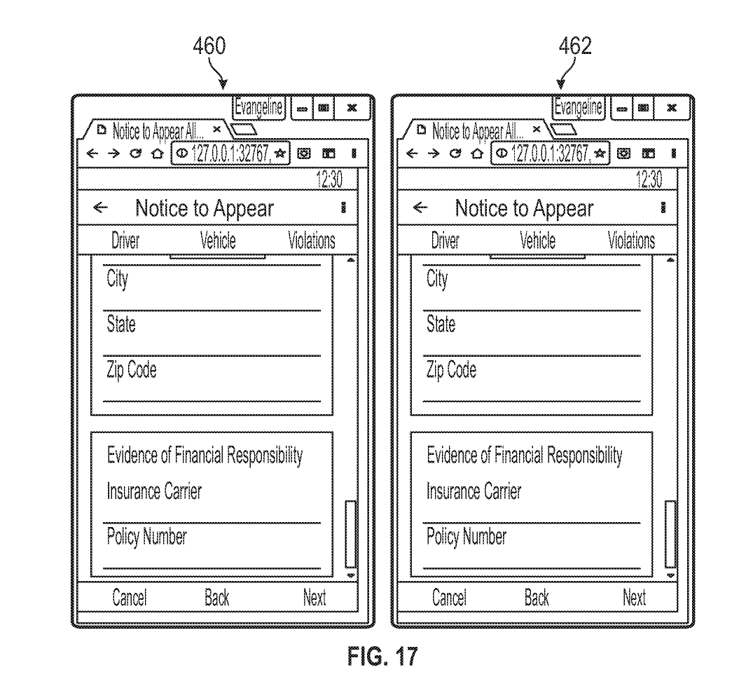

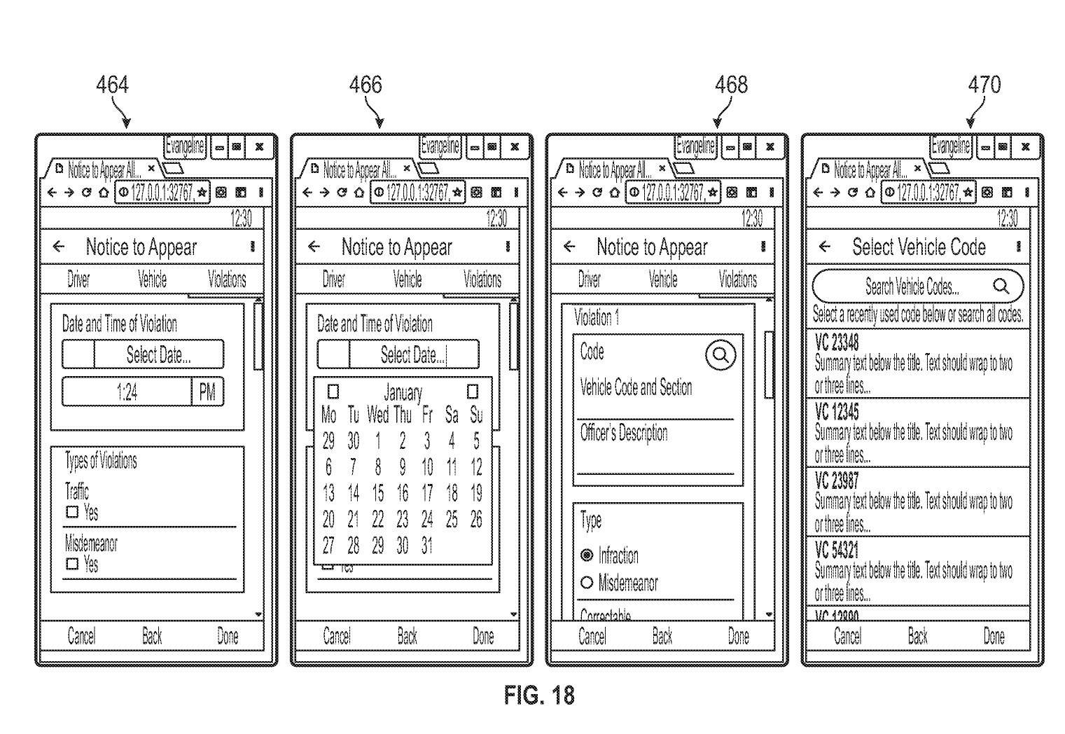

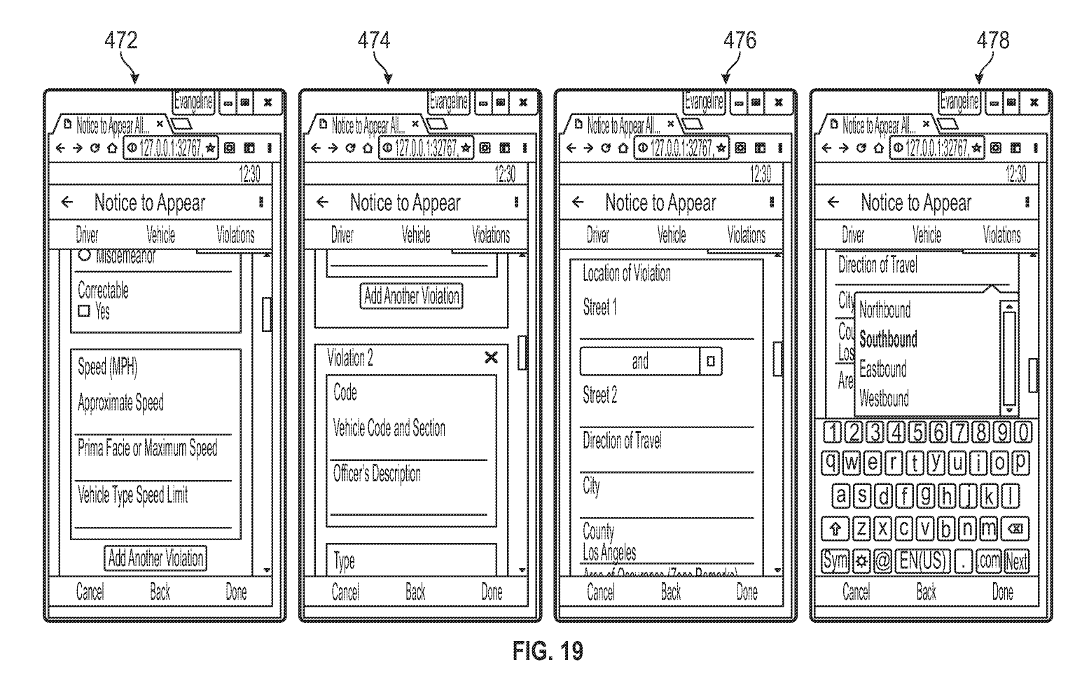

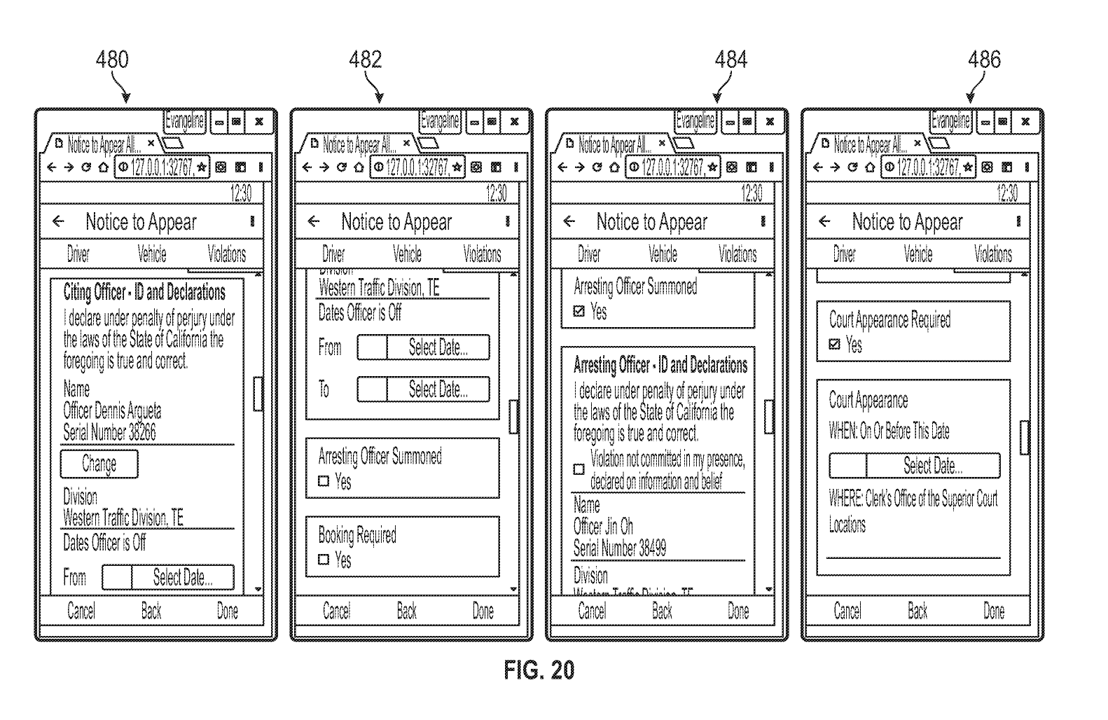

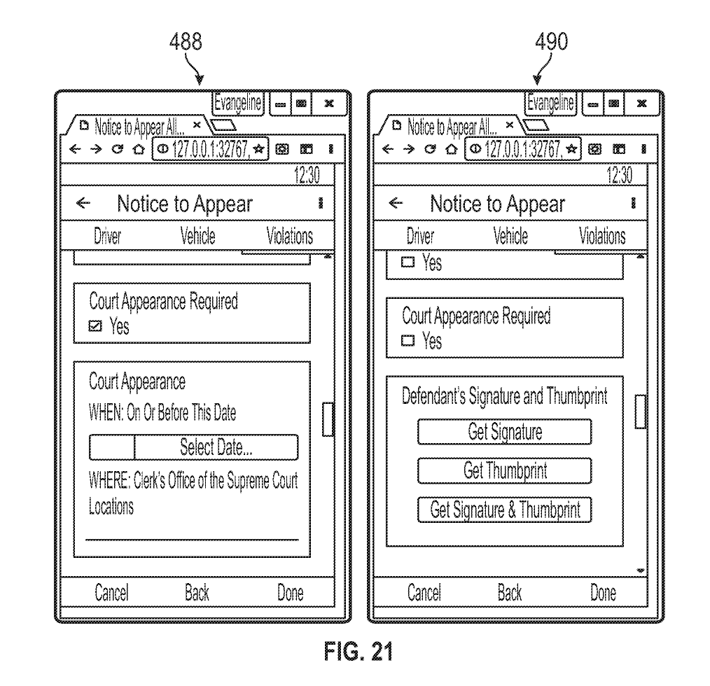

FIG. 13 illustrates screen shots of screens 432, 434, 436, and 438 for obtaining a driver signature, in accordance with an example embodiment. FIG. 14 illustrates screen shots of screens 440, 442, and 444 for obtaining a driver fingerprint, in accordance with an example embodiment. FIG. 15 illustrates screen shots of screens 446, 448, and 450 for obtaining a driver thumbprint, in accordance with an example embodiment. FIGS. 16-17 illustrate screen shots of screens 452, 454, 456, 458, 460, and 462 associated with a vehicle tab, in accordance With an example embodiment. FIGS. 18-21 illustrate screen shots of various screens 464, 466, 468, 470, 472, 474, 476, 478, 480, 482, 484, 486, 488, and 490 associated with a violations tab, in accordance with an example embodiment.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

FIGS. 2-3 are thus intended as examples and not as architectural limitations of disclosed embodiments. Additionally, such embodiments are not limited to any particular application or computing or, data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

The claims, description, and drawings of this application may describe one or more of the instant technologies in operational/functional language, for example, as a set of operations to be performed by a computer. Such operational/functional description in most instances can be specifically configured hardware (e.g., because a general purpose computer in effect becomes a special-purpose computer once it is programmed to perform particular functions pursuant to instructions from program software). Note that the data-processing system/apparatus discussed herein may be implemented as special-purpose computer in some example embodiments. In some example embodiments, the data-processing system/apparatus can be programmed to perform the aforementioned particular instructions (e.g., such as the various steps and operations described herein with respect to FIG. 10 thereby becoming in effect a special-purpose computer). In other example embodiments, the data-processing system/apparatus may be a general-purpose computer.

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein can be a distillation of machine specifications or other physical mechanisms specified by the operations/functions such that the otherwise inscrutable machine specifications may be comprehensible to the human mind. The distillation also allows one skilled in the art to adapt the operational/functional description of the technology across many different specific vendors' hardware configurations or platforms without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, Java, Visual Basic, etc.), or tools in the form of Very high speed Hardware Description Language (“VHDL,” which is a language that uses text to describe logic circuits)—are generators of static or sequenced specifications of various hardware configurations. The broad term “software” sometimes obscures this fact but, as shown by the following explanation, what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In an example embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each, type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a micro architecture that will carry out the instructions defined by that microprocessors defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “1”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second).

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification, which selects out hardware logic gates, specifies voltage levels, voltage transition timings, etc., such that the humanly useful work is accomplished by the hardware.

Thus, a functional/operational technical description, when viewed by one skilled in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object, which has a stable, measurable, and changeable state may be used to construct a machine based on the above technical description. Charles Babbage, for example, constructed the first computer out of wood and powered by cranking a handle.

Thus, far from being understood as an abstract idea, it can be recognized that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc., with natural language simply cannot be taken as an indication that such functional/operational technical descriptions are abstract ideas, or mere expressions of abstract ideas. In fact, as outlined herein, in the technological arts this is simply not true. When viewed through the tools available to those skilled in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person skilled in the art in understanding the described subject matter by providing a description that is more or less independent of any specific vendors piece(s) of hardware.

The use of functional/operational technical descriptions assists the person skilled in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person skilled in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those skilled in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one skilled in the art can readily understand and apply in a manner independent of a specific vendors hardware implementation.

At least a portion of the devices or processes described herein can be integrated into an information processing system/apparatus. An information processing system/apparatus generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc., in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably coupleable” to each other to achieve the desired functionality. Specific examples of operably coupleable include, but are not limited to, physically mateable, physically interacting components, wirelessly interactable, wirelessly interacting components, logically interacting, logically interactable components, etc.

In an example embodiment, one or more components may be referred to herein as “configured to,” “configurable to,” “operable/operative to,” “adapted adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs) or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and/or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A user interface method facilitated by a client device, said method comprising:
displaying, by said client device, at least one screen of a user interface that allows a law enforcement officer to quickly collect, manage, and issue a citation to a violator through said client device in a minimal time.

2. The method of claim 1 wherein said user interface comprises a gestural touch screen user interface.

3. The method of claim 1 wherein said at least one screen permits said law enforcement officer to capture information by a touch entry or a touch selection.

4. The method of claim 1 wherein said at least one screen permits said law enforcement officer to capture information by connecting with at least one in-vehicle database to automatically ingest required citizen information.

5. The method of claim 1 wherein said at least one screen permits said law enforcement officer to capture information by ingesting information from at least one optical scanner.

6. The method of claim 1 wherein said at least one screen permits said law enforcement officer to capture information by ingesting information from at least one barcode scanner.

7. The method of claim 1 further comprising automatically error checking information associated with said citation prior to completion of said citation through said client device.

8. A user interface apparatus facilitated by a client device, said apparatus comprising:
at least one screen of a user interface displayable by a client device, which allows a law enforcement officer to quickly collect, manage, and issue a citation to a violator through said client device in a minimal time.

9. The apparatus of claim 8 wherein said user interface comprises a gestural touch screen user interface.

10. The apparatus of claim 8 wherein said at least one screen permits said law enforcement officer to capture information by a touch entry or a touch selection.

11. The apparatus of claim 8 wherein said at least one screen permits said law enforcement officer to capture information by connecting with at least one in-vehicle database to automatically ingest required citizen information.

12. The apparatus of claim 8 wherein said at least one screen permits said law enforcement officer to capture information by ingesting information from at least one optical scanner.

13. The apparatus of claim 8 wherein said at least one screen permits said law enforcement officer to capture information by ingesting information from at least one barcode scanner.

14. The apparatus of claim 8 wherein automatic error checking of information is associated with said citation prior to a completion of said citation through said client device.

15. A user interface system facilitated by a client device, said system comprising:
at least one processor; and
a non-transitory computer-usable medium embodying computer program code, said computer-usable medium capable of communicating with said at least one processor, said computer program code comprising instructions executable by said at least one processor and configured for:
displaying, by said client device, at least one screen of a user interface that allows a law enforcement officer to quickly collect, manage, and issue a citation to a violator through said client device in a minimal time.

16. The system of claim 15wherein said user interface comprises a gestural touch screen user interface.

17. The system of claim 15 wherein said at least one screen permits said law enforcement officer to capture information by a touch entry or a touch selection.

18. The system of claim 15 wherein said at least one screen permits said law enforcement officer to capture information by connecting with at least one n-vehicle database to automatically ingest required citizen information.

19. The system of claim 15 wherein said at least one screen permits said law enforcement officer to capture information by ingesting information from at least one optical scanner and/or from at least one barcode scanner.

20. The system of claim 15 wherein said instructions are further configured for comprising automatically error checking information associated with said citation prior to completion of said citation through said client device.
